(19) United States
(12) Patent Application Publication
(10) Pub. No.: US 2016/0376189 A1
(43) Pub. Date: Dec. 29, 2016

(54) Systems for Marking Impervious Substrates, Surfaces and Resultory Products Thereby

(71) Applicant: Chris Palicke, Yorba Linda, CA (US)

(72) Inventor: Chris Palicke, Yorba Linda, CA (US)

(21) Appl. No.: 15/191,467

(22) Filed: Jun. 23, 2016

Related U.S. Application Data
(60) Provisional application No. 62/183,567, filed on Jun. 23, 2015.

(51) Int. Cl. C03C 17/00; B41J 2/01

(52) U.S. Cl. CPC C03C 17/001; B41J 2/01

(57) ABSTRACT

A temperature sensitive ink and delivery system enables non-permanent marking of, for example, impervious—glassine surfaces and substrates being removable between at least about 120 degrees and 150 degrees Fahrenheit.

### CROSS REFERENCE TO RELATED MATERIALS—EXPRESSLY INCORPORATED BY REFERENCE

ASTM D-4236; U.S. Pat. Nos. 5,116,410; 5,968,241; 8,174,938; 5,334,649; 6,048,914; 5,261,755; 4,812,071; D319,469; and Chinese Patent CN2176252 are expressly incorporated by reference herein, respectively, as if each was fully set forth herein.

### BACKGROUND OF THE INVENTION

The present disclosure related to systems for making impervious surfaces. In particular, the present disclosures comprise non-toxic, water or solvent bome temperature sensitive inks which conform to ASTM D-4236, along with delivery, application and/or administration systems for the same, separately and in combination.

### BRIEF SUMMARY OF THE INVENTION

Briefly stated, subject systems include ink applied with low VOC delivery, water immersion resistance greater than an hour, abrasion resistance, adherence to glass, metals and plastics wherein film thickness is sufficient for opacity/marking with a cure time ranging from 7 to 100 seconds, which is safe as a consumer product and removable in hot water between at least about 120 and 150 degrees Fahrenheit.

According to embodiments systems are disclosed whereby at least an ink solution which does not rub-off under normal handling, even when a surface upon which the at least an ink solution is coated is wet and/or houses a condensate; wherein at a predetermined break down temperature an Inherent sensitivity in the at least an ink solution and/or further additional material, causes a break down chemically releasing the ink from said surface and means for delivering said at least an Ink solution.

According to embodiments systems are disclosed whereby the surface is impervious, such as the surfaces of glasses and resins.

According to embodiments systems are disclosed wherein the formula is wax based, includes resin and the like moieties, or in exclusionary embodiments leverages chemically distinct constituents along with the above.

### EXAMPLE

Personal items, such as glasses for housing drinks, present unique challenges for identification/individualization. See U.S. Pat. No. 5,678,809 for example, for basis for needing personal, scientific, recreational and artistic differentiators that continue to evolve.

According to the present disclosures, systems are offered for consideration which enable users to, for example make temporary/non-permanent etchings, markings, drawings, symbols, strings or other figures or characters upon their glassware. Such inks, with moisture resistance, can later be removed in dishwashers.

### DETAILED DESCRIPTION OF THE INVENTION

The present inventor has created systems for delivery, administration, application of temperature sensitive inks, particularly useful for temporarily marking impervious surfaces.

Colored and non-colored inks and coatings for glassine surfaces are offered for consideration.

The solution can be described as a solvent, preferably water based, ink formula including a pigmented, acrylic and wax emulsion. Benefits of the solution include, but are not limited to the following desiderata:
A melting point of approximately 120 F-130 F. This is necessary for washability in standard household kitchens, including within a dishwasher.
Dry time between 1-5 minutes at 77 F.
Abrasion resistance of moderate pressure of 35 double rubs wet or dry.
Excellent adhesion to glass and hard surfaces such as, plastics, stainless steel, ceramic tiles or mugs.
Excellent adhesion to glass while under moist, wet, humid conditions at room temperature.
The solution is removable when heated to approximately 120 F for 10 or more seconds, typically using hot water, and rubbed off with a sponge.
Any color can be produced.
With no colorant added the solution is clear/transparent.
Substrates for use include, but are not limited to, glass, hard plastics, stainless steel, ceramic, hard non-pores rock and stone, metal, and other hard non-pores substrates.

Ink Solution Additives
Color changing temperature sensitive crystals can be introduced which will cause the solution to change color as the temperature changes. For example, if the glass writable pen solution with color changing crystals was used to mark a drink glass, the color of the ink solution would be one color, such as, blue when the glass was cold or filled with ice; When the drink glass warms above a certain temperature such as 60 F or 70 F the color would change to another color, such as. red. Varying colors can be used.
Glow in the dark additives can be introduced which will cause the solution to glow in dark environments. Almost any color can be achieved.

The second component of the instant disclosure is a casing. The casing is a plastic shell with a metal applicator tip which allows for thicker ink solutions to flow. The pen is commonly used for white-out application. The pen will have a squeezable casing along with a metal agitator in the solution storage compartment. Before use, the pen must be shaken so the metal agitator can stir or mix the solution for best consistency.

Likewise, addressed according to the instant teachings are product packaging and disclaimers—Conforms to ASTM D-4236, instructions for use, bar code, graphics, ink, as further discussed and managed to date.

The projected market includes anyone who drinks liquids from glass, plastic, metal or other solid cups and sees value in either the entertainment or sanitary aspects of the product. The instant disclosure can be adjusted to meet a variety of needs, service and environments. Focus groups have researched the following customer-focused needs, for which prototypes and working models, pre-production samples are being likewise created, tested and managed.
Family home—used for marking kids drinking cups, glasses, windows, plastic or stainless water bottles, wine glasses, beer glasses, other beverage glasses.
Parties, such as, weddings where drink glasses, vases, and other substrates can be decorated and personalized without concern of damaging or permanently marking the surface.
Wineries & Breweries—used for marking wine and beer glasses and/or storage containers. Bars, restaurants and storefronts—used for marking drink glasses, decorating windows or other substrates.
Pet stores—used for marking fish tanks, or animal enclosures with prices and sales information.
Industrial—used for marking equipment, such as, mechanical, piping, or storage. Also used for marking doors and windows with directions, dates, or codes.
Schools—used for playful decorating and coloring.
Painting—used as a semi-permanent paint or coating.
Government or military—used for marking equipment, weapons, guns, vehicles, storage tanks, storage containers.
Marine—used for marking marine equipment, boats, housings, windows.
Art—used for various artistic projects as a decorative marking or semi-permanent coating, kits, teaching tools, club activities, sports team building events and the like

According to embodiments the first table shows some embodiments as claimed below.

| | | Percentage | |
|---|---|---|---|
| Item or instruction | Name | by Weight | Range +/− |
| Weigh into a clean tank in | | | |
| order listed. Choose a tank | | | |
| that will allow enough free | | | |
| space above it to enable the | | | |
| batch to have movement up | | | |
| the sides without spilling | | | |
| over. For example, for 100 | | | |
| gallon batch, use a 110 gallon | | | |
| tank, Wear nitrite gloves and | | | |
| safety glasses. Check to see if | | | |
| drain in tank is clean and | | | |
| closed. Use Wilden air | | | |
| actuated pump to minimize | | | |
| back strain and repetitive | | | |
| motion injury. Wear steel toed | | | |
| shoes to prevent foot injury. | | | |
| Avoid splashing liquid to | | | |
| prevent air entrainment | | | |
| RWAC.HD21A | RHOPLEX | 45.00 | 20 |
| Dow Chemical, Inc. | HD 21A | | |
| Add under agitation, 1000 rpm. | | | |
| Keep agitation mixer blade low | | | |
| enough under the surface to | | | |
| prevent vortex which would lead | | | |
| to air entrapment but high | | | |
| enough to keep liquid in tank | | | |
| moving. The liquid should be | | | |
| in a flat line across the top of | | | |
| the liquid to seal air out of the | | | |
| batch. | | | |
| SW.H20 | Tap Water | 30.00 | 20 |
| CWRO.RU11006F | Heucotint | 5.00 | 2 |
| Hueco Tech Inc. | RU11006F | | |
| AWX.70750 | Michem | 13.90 | 5 |
| Michaelman Inc. | 70750 | | |
| APR.GXL | Proxel | 0.10 | .05 |
| Arch Chemical Inc. | GXL | | |
| Wear dust mask, increase | | | |
| speed on mixer to quickly | | | |
| incorporate powder into batch, | | | |
| then reduce speed and lower | | | |
| blade, below the level where air | | | |
| is sucked into the batch. | | | |
| Pl. Aerosil 380 | Aerosil | 6.00 | 2 |
| Evonik Industries Inc. | 380 | | |
| Make a panel using 0.10 mil | | | |
| drawdown bar. Check color, dry t [symbol] | | | |
| gloss against standard. | | | |
| Total | | 100.00 | |

[symbol]

indicates data missing or illegible when filed

According to embodiments, tested and formulated anything that works may be used and often water is a preferred solvent. However, if another solvent solution is to be employed, preferably it would use either methyl or ethyl alcohol. If methyl or ethyl alcohol is employed, an alternative resign would need to be used.

Those skilled in the art readily understand that fluid dispensers, White-Out® containers and many pottery tools can be used to dispense the ink of the instant teachings. Ink-wells, replaceable cartridges, printing cartridges and the like may be used according to the instant teachings.

Similarly, the present invention may be used in conjunction with three-dimensional printing systems, ink-jet printers and wirelessly installed automatic printing systems, among other things.

Valves, agitators and known mechanical means for stirring are likewise taught as available off-of the-shelf and detailed in patents.

With respect to ink delivery, those skilled in the art realize that as blended—in final form fewer challenges present themselves, for the presently disclosed systems.

The lack of water or moisture resistivity is why most conventional, for example, drinking vessels cannot be adequately marked or designated with known inking systems. If condensate becomes deposited on such impervious substances, often impacting printing, symbols or colors attempted to be arrayed on an outer surface. Another risk is blurring, or granting—based “running” of liquid precipitations mixed with condensate. Many solutions have been proposed to address dripping from glasses, see for example U.S. Pat. No. 5,678,809 likewise expressly incorporated by reference herein. Prior to the advent of the instant teachings external devices, coasters, ribbons or other items were needed, for example, to differentiate beverage glasses at an event.

Using the temperature sensitive ink of the instant teachings a break-down event is designed to occur between at least about 120 and 150 degrees Fahrenheit—rendering the disclosures of the instant inventions temporary. Returning to the prior example, either stem-ware, children's glasses or even bottled containers can be marked—for example for any number of invited guest at an event—the markings can serve to differentiate the respective glasses of Invitees. Marking-devices, pens and related dispensers according to the present disclosures can be used to apply colors, strings of characters, names and symbols to the glass surfaces being used, prior to or upon distribution.

Following the aforementioned social event, said drinking vessels can then be collected, placed in any conventional dish washing or related equipment and rinsed with water ranging between at least about 120 degrees to approximately 150 degrees Fahrenheit, and the markings removal.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “In an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown

What is claimed:

1. A system for non-permanently marking a surface, comprising, in combination:
at least an ink solution which does not rub-off under normal handling, even when a surface upon which the at least an ink solution is coated is wet and/or houses a condensate;
wherein at a predetermined break down temperature an inherent sensitivity in the at least an ink solution and/or further additional material, causes a break down chemically releasing the ink from said surface and means for delivering said at least an ink solution.

2. The system of claim 1, whereby the surface is impervious, such as the surfaces of glasses and resins.

3. The system of claim 2, wherein the formula is wax based.

4. The system of claim 3, further comprising any resultory ink based desiderata such as flow; viscosity; hand of device for user; streaking and the like moderated by known chemical modification such as inclusion of water and alcohol resistance via vinyl resin and/or fluorinated surfactant incorporation.

5. The system of claim 4, any of the claims herein, specification wherein the at least an ink system is removable based upon a break point of at least about 120 to 125 degrees F.

6. The system of claim 5, any claims herein, wherein said at least an ink system is removable based upon a break point of at least about 125 to 130 degrees.

7. The system of claim 5, any claims herein, wherein said system is removable based upon a break point of at least about 130 degrees F. to 140 degrees.

8. The system of claim 5, based upon any of the claims herein having a break point of at least about 120 degrees F. to 150 degrees F.

9. In combination, at least a water or solvent borne ink formula, pigmented, acrylic and wax emulsion optionally disposable within a means for delivery, wherein a melting or break point ranges from at least about 120 degrees to 150 degrees F.

10. The combination of claim 9, and any other disclosures herein, having adhesion to glass while under moist, wet, humid conditions at least about 120 degrees to 150 degrees F.

11. A process of generating at least a removable ink, comprising, in combination:
weighing a predetermined aliquot of an admixture of constituents from the specification herein, and incorporated patents; agitating the admixture of at least about 1000 rpm, whereby the liquid is in a flat line across the top of the liquid to seal air out of the batch;
combining other desired elements by weight percentage; and finishing a subject removable ink;
optionally emplacing the same in a means-for-delivery.

12. The system of claim 8, further comprising any combination of ingredients selected from the group of RHOPLEX HD21A; HEUCOTINT RU11006 F; MICHEM 70750; PROXEL DXL; AEROSIL 380 and the like moieties.
